(19) United States
(12) Patent Application Publication
(10) Pub. No.: US 2016/0080498 A1
(43) Pub. Date: Mar. 17, 2016

(54) Scalable Charging System Based On Service-Oriented Architecture

(71) Applicant: Convida Wireless, LLC, Wilmington (DE)

(72) Inventor: Guang Lu, Ontario (CA)

(21) Appl. No.: 14/851,653

(22) Filed: Sep. 11, 2015

Related U.S. Application Data
(60) Provisional application No. 62/049,696, filed on Sep. 12, 2014.

(51) Int. Cl. H04L 29/08

(52) U.S. Cl. CPC H04L 67/12; H04L 67/303; H04L 67/22

(57) ABSTRACT

An Event Collection service for a oneM2M SOA charging system can provide service capabilities to enable configuration of charging policies, i.e. the common rules for event collection; can provide service capabilities to enable configuration of event collection triggers, i.e. at what specific event it will trigger the collection operation; can define a system which can scale up with increases of services, devices and applications and can define a system that can interact and integrate with the oneM2M ROA charging system.

This patent application claims benefit of U.S. Provisional Patent Application Ser. No. 62/049,696 filed Sep. 12, 2014, the disclosure of which is hereby incorporated by reference as set forth in its entirety herein.

### BACKGROUND

oneM2M is an organization that develops technical specifications which address the need for a common Machine-to-Machine (M2M) Service Layer that can be readily embedded within various hardware and software, and relied upon to connect the myriad of devices in the field with M2M application servers worldwide.

FIG. 1 is a diagram that illustrates an architecture 100 of a M2M Service Platform as defined in the oneM2M Functional Architecture. The M2M Service Platform includes an entity described as the Common Service Entity (CSE) 102. The CSE 102 comprises a set of service functions that common to the M2M environment and are exposed through the Mca and Mcc′ Reference Points. These Reference Points are described in the oneM2M Functional Architecture. The M2M Service Architecture described in that specification is primarily suitable for the Infrastructure Domain where the CSE 102 is viewed as a set of Service Components.

The M2M Service Architecture augments the oneM2M Functional Architecture by specifying M2M Services provided to M2M Application and M2M Service Providers.

These M2M Services are consumed by Application Entities (AEs) 104 across the Mca reference point via the Service Exposure Component 106; Other Infrastructure CSEs across the Mcc′ reference point via the Remote Service Exposure Component 108; and Other Service Components across the Msc reference point 110

These M2M Services utilize services of the Underlying Network through Network Service Exposure (NSE) 112 across the Mcn reference point via the Network Service Utilization Component 114

Application Entity (AE) 104 is defined by the oneM2M Functional Architecture. The Application Entity provides Application logic for the end-to-end M2M solutions.

Common Services Entity (CSE) 102 is defined by the oneM2M Functional Architecture. A Common Services Entity 102 comprises the set of “service functions” that are common to the M2M environments and specified by oneM2M. For oneM2M Services, this definition of a CSE 102 is a logical representation where “service functions” that are exposed through the Mca and Mcc′ reference points via the corresponding Service Exposure component 106 and Remote Service Exposure Component 108. Network Service Utilization Component 114 utilizes services of the Underlying Network through the Mcn referent point. In addition, Service Components consume and provide M2M Services with other Service Components 115 and 116.

As a logical representation of loosely coupled Service Components, the CSE 102 is entity that is itself is identifiable but not directly addressable. Instead the addressable entities are the corresponding Service Exposure Components of the reference points. Services are the addressable entities within components; components are not directly addressable.

The Service Exposure Component 106 exposes services to AEs. The Network Service Utilization Component 114 consumes services from the NSE. The Remote Service Exposure Component 108 connects Services from different M2M environments.

The Service Exposure component 106, Network Service Utilization component 114 and Remote Service Exposure Component 108 follow the CSE Public Domain Names convention but are extended as a sub-domain of the Infrastructure Node public domain name. FIG. 2 is a diagram that illustrates exemplary service components that can be used with the oneM2M Services architecture 100 of FIG. 1.

The following table 1 shows common SOA parameters:

TABLE 1
Common Service Capability Parameters

| Parameter | | | |
|---|---|---|---|
| name | Direction | Optional | Description |
| originator | IN | NO | The identifier of the originator |
| | | | that is issuing the request. |
| subscriptionId | IN | NO | The M2M Service Subscription |
| | | | Identifier (M2M-SUB-ID) |
| from | IN | NO | The identifier of the Originator |
| | | | of the request (AE-ID) |
| to | IN | NO | The identifier of the AE that is |
| | | | to target of the request |
| | | | (AE-ID) |
| responseType | OUT | YES | Response types that are relevant |
| | | | to the Authentication and |
| | | | Authorizations of requests from |
| | | | AEs across the Mca reference |
| | | | point. |
| | | | Originator is not authenticated |
| | | | Originator does not have a |
| | | | Service Subscription |
| | | | Originator not authorized for |
| | | | the Service Capability |

The direction is relative to the entity that provides (implements) the Service Capability. The value “IN” means that the entity expects to receive a value for the parameter from the consumer (sender) of the Service Capability request. The value “Out” means that the entity will send a value for the parameter to the consumer (sender) of the Service Capability request. A value of “IN-OUT” means that the entity will receive the value for the parameter from the consumer and then send a value (not necessarily the same value) for the parameter back to the consumer.

The table 2 defines the filterCriteria.

TABLE 2
Supporting Service Filter Criteria

| Criterion name | Description |
|---|---|
| serviceId | The Supporting Service Identifier (M2M-Serv-ID). |
| labels | One or more labels assigned to the Supporting Service |
| | entity. |
| serviceRoleIds | One or more Service Role Identifiers (Role-ID) |
| | associated with the Supporting Service entity. |
| lastModifiedTime | See Table 1 |
| creationTime | See Table 1 |

SOA (Service Oriented Architecture) is a system and software design principle and style commonly used in the enterprise deployments. SOA defines functionalities as distributed services and provides interfaces for service consumers.

At oneM2M, there is a ROA (Resource Oriented Architecture) specification and as well as a SOA (Service Oriented Architecture) specification.

### SUMMARY

This application describes a scalable frame work for a SOA charging feature. An Event Collection service can provide service capabilities to enable configuration of charging policies, i.e. the common rules for event collection; can provide service capabilities to enable configuration of event collection triggers, i.e. at what specific event it will trigger the collection operation; can define a system which can scale up with increases of services, devices and applications and can define a system that can interact and integrate with the oneM2M ROA charging system. For example, the events recorded by the triggers can be used in a billing application to charge the appropriate party.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with accompanying drawings wherein:

FIG. 1 is a diagram that illustrates an architecture of the M2M Service Platform as defined in the oneM2M Functional Architecture.

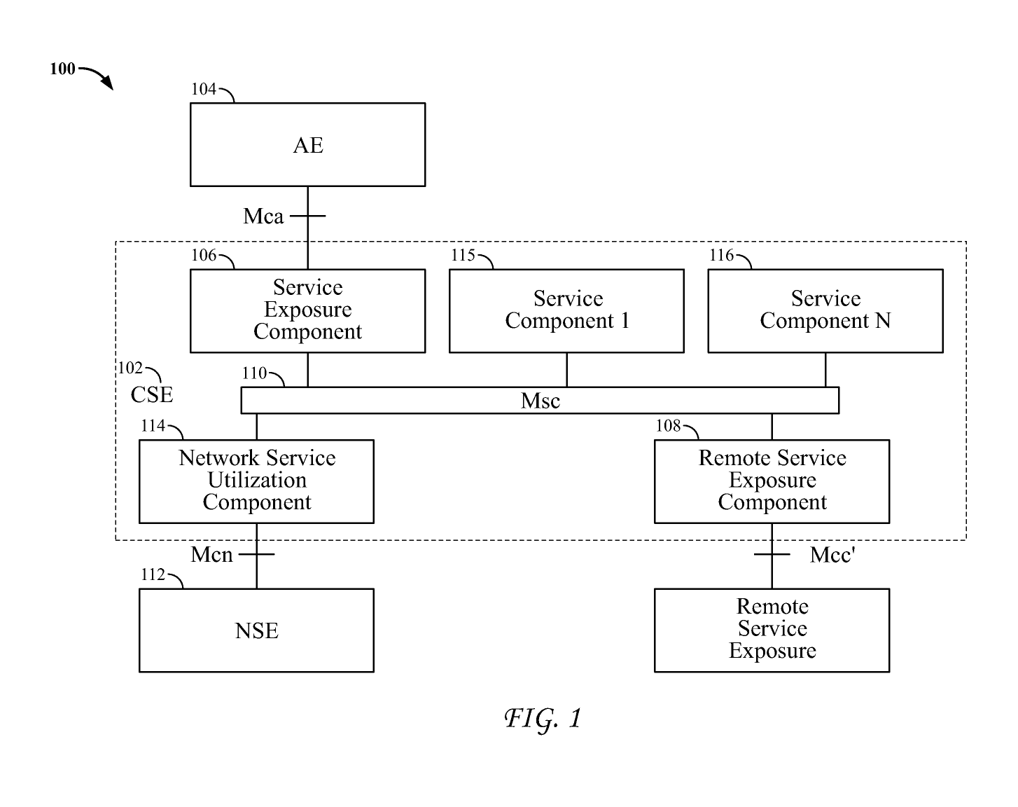

FIG. 2 is a diagram that illustrates exemplary service components that can be used with the oneM2M Services architecture of FIG. 1.

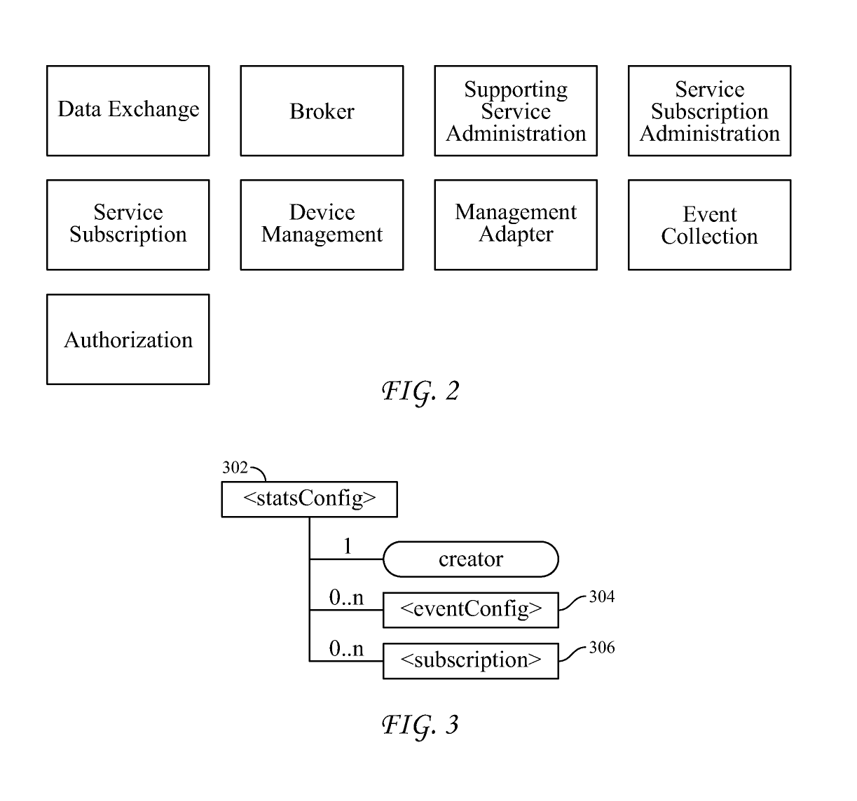

FIG. 3 is a diagram that illustrates a <statsConfig> resource that can be used to store configuration statistics for Application Entities (AEs) in a Charging Resource Structure based on ROA (Resource Oriented Architecture).

FIG. 4 is a diagram that illustrates a <eventConfig> sub-resource of the <statsConfig> resource of FIG. 3.

FIG. 5 is a diagram that illustrates a <statsCollect> resource that can be used to collect information for AEs using the <eventConfig> resource of FIG. 3 as the triggers for a IN-CSE.

FIG. 6 is a diagram that illustrates a Service-Oriented Architecture (SOA) event collection architecture.

FIG. 7 is a diagram that illustrates how the event collection triggers can be distributed at different services.

FIG. 8 is a diagram that illustrates the event collection service as a service component in a oneM2M SOA Functional architecture.

FIG. 9 is a flow chart that illustrates an exemplary setEventCollectionPolicy messaging.

FIG. 10 is a flow chart that illustrates an exemplary getEventCollectionPolicy messaging.

FIG. 11 is a flow chart that illustrates an exemplary setEventCollectionTriggers messaging.

FIG. 12 is a flow chart that illustrates an exemplary getEventCollectionTriggers messaging.

FIGS. 13A and 13B are diagrams that show an exemplary sequence of event collection.

FIG. 14 is a diagram of a Graphical User Interface of one embodiment.

FIG. 15A is a system diagram of an example machine-to-machine (M2M), Internet of Things (IoT), or Web of Things (WoT) communication system in which one or more disclosed embodiments may be implemented.

FIG. 15B is a system diagram of an example architecture that may be used within the M2M/IoT/WoT communications system illustrated in FIG. 15A.

FIG. 15C is a system diagram of an example M2M/IoT/WoT terminal or gateway device that may be used within the communications system illustrated in FIG. 15A.

FIG. 15D is a block diagram of an example computing system in which aspects of the communication system of FIG. 15A may be embodied.

### DETAILED DESCRIPTION OF ILLUSTRATIVE EMBODIMENTS

Charging Resource Structure based on ROA (Resource Oriented Architecture)

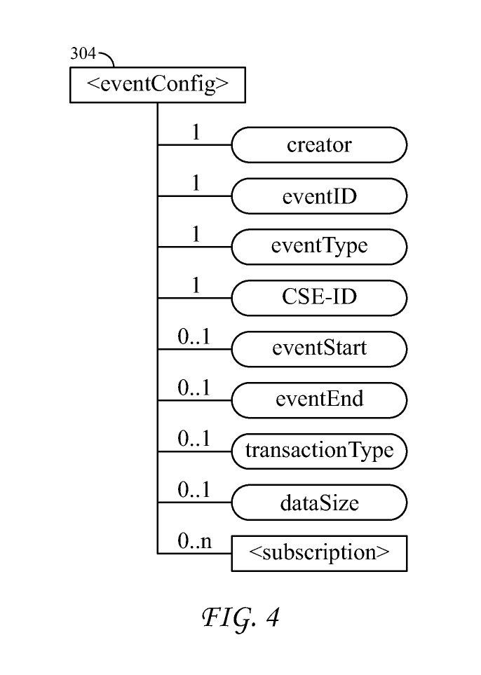

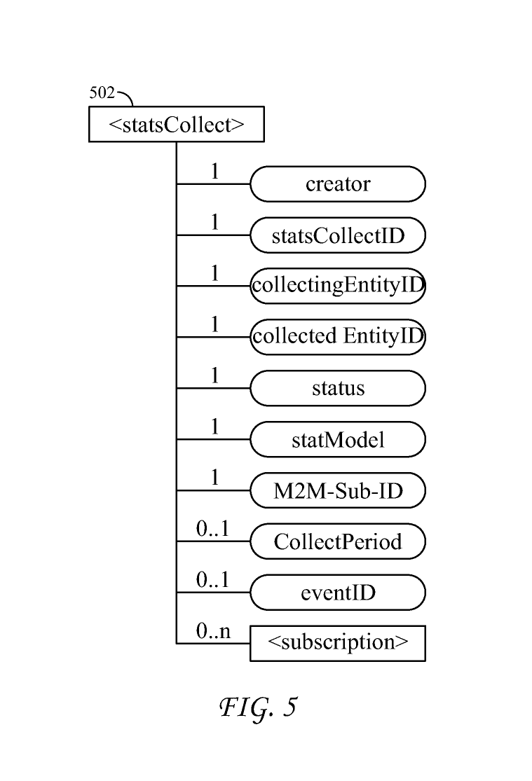

FIG. 3 is a diagram that illustrates a <statsConfig> resource 302 that can be used to store configuration statistics for Application Entities (AEs) in a Charging Resource Structure based on ROA (Resource-Oriented Architecture). The <statsConfig> resource 302 may be established by the IN-CSEs or by AEs in IN-CSE. The <statsConfig> resource 302 can be located directly under <CSEBase>. <eventConfig> sub-resource 304 can be used to define events that trigger statistics collection. FIG. 4 is a diagram that illustrates a <eventConfig> sub-resource 304 of the <statsConfig> resource of FIG. 3.

Below are some examples of events that can be generated:
Collection based on a certain operation: collects any RETRIEVE operations on the data created by the collecting entity.
Collection based on storage size: collects the size of storage when a <container> resource created by the collecting entity exceeds a quota.
Combined configuration: collects all RETRIEVE operations on the data created by the collecting entity during a period of time.

The <statsConfig> resource 302 can contain the child resources specified in table 3.

TABLE 3
Child resources of <statsConfig> resource

| Child | | | |
|---|---|---|---|
| Resources of | Child Resource | | |
| <statsConfig> | Type | Multiplicity | Description |
| [variable] | <eventConfig> | 0 . . . n | This resource configures |
| | 304 | | an event for statistics |
| | | | collection. |
| [variable] | <subscription> | 0 . . . n | The <subscription> |
| | | | resource contains |
| | | | subscription information |
| | | | for its subscribed-to |
| | | | resource. The subscribed- |
| | | | to resource is the |
| | | | resource that has the |
| | | | <subscription> resource |
| | | | as the child resource. |

The <statsConfig> resource 302 can contain the attributes specified in table 4

TABLE 4
Attributes of <statsConfig> resource

| | | RW/ | |
|---|---|---|---|
| Attributes of | | RO/ | |
| <statsConfig> | Multiplicity | WO | Description |
| resourceType | 1 | RO | common attribute described at clause 9.6.1 of |
| | | | oneM2M functional architecture |
| resourceID | 1 | WO | common attribute described at clause 9.6.1 of |
| | | | oneM2M functional architecture |
| parentID | 1 | RO | common attribute described at clause 9.6.1 of |
| | | | oneM2M functional architecture |
| accessControlPolicyIDs | 1 (L) | RW | common attribute described at clause 9.6.1 of |
| | | | oneM2M functional architecture |
| creationTime | 1 | RO | common attribute described at clause 9.6.1 of |
| | | | oneM2M functional architecture |
| expirationTime | 1 | RW | common attribute described at clause 9.6.1 of |
| | | | oneM2M functional architecture |
| lastModifiedTime | 1 | RO | common attribute described at clause 9.6.1 of |
| | | | oneM2M functional architecture |
| labels | 0 . . . 1 | RW | common attribute described at clause 9.6.1 of |
| | | | oneM2M functional architecture |
| creator | 1 | RW | The AE-ID or CSE-ID of the entity which created |
| | | | the resource. |

The <eventConfig> resource 304 can contain the child resource specified in table 5.

TABLE 5
Child resources of <eventConfig> resource

| Child Resources of | Child Resource | | |
|---|---|---|---|
| <eventConfig> | Type | Multiplicity | Description |
| [variable] | <subscription> | 0 . . . n | The <subscription> resource |
| | 402 | | contains subscription information for |
| | | | its subscribed-to resource. The |
| | | | subscribed-to resource is the |
| | | | resource that has the <subscription> |
| | | | resource as the child resource. |

The <eventConfig> resource 304 can contain the attributes specified in table 6

TABLE 6
Attributes of <eventConfig> resource

| | | RW/ | |
|---|---|---|---|
| Attributes of | | RO/ | |
| <eventConfig> | Multiplicity | WO | Description |
| resourceType | 1 | RO | common attribute described at clause 9.6.1 of |
| | | | oneM2M functional architecture |
| resourceID | 1 | WO | common attribute described at clause 9.6.1 of |
| | | | oneM2M functional architecture |
| parentID | 1 | RO | common attribute described at clause 9.6.1 of |
| | | | oneM2M functional architecture |
| accessControlPolicy | 1 (L) | RW | common attribute described at clause 9.6.1 of |
| IDs | | | oneM2M functional architecture |
| creationTime | 1 | RO | common attribute described at clause 9.6.1 of |
| | | | oneM2M functional architecture |
| expirationTime | 1 | RW | common attribute described at clause 9.6.1 of |
| | | | oneM2M functional architecture |
| lastModifiedTime | 1 | RO | common attribute described at clause 9.6.1 of |
| | | | oneM2M functional architecture |
| labels | 0 . . . 1 | RW | common attribute described at clause 9.6.1 of |
| | | | oneM2M functional architecture |
| creator | 1 | RW | The AE-ID or CSE-ID of the entity which created |
| | | | the resource. |
| eventID | 1 | RO | This attribute uniquely identifies the event to be |
| | | | collected for statistics for AEs. |
| eventType | 1 | RW | This attribute indicates the type of the event, such |
| | | | as timer based, data operation, storage based, etc. |
| eventStart | 0 . . . 1 | RW | This attribute indicates the start time of the event. |
| eventEnd | 0 . . . 1 | RW | This attribute indicates the end time of the event |
| transactionType | 0 . . . 1 | RW | This attribute defines the type of the operation to |
| | | | be collected by statistics, such as CREATE, |
| | | | RETRIEVE. |
| dataSize | 0 . . . 1 | RW | This attribute defines the data size if an event is |
| | | | triggered when the stored data exceeds a certain |
| | | | size. |

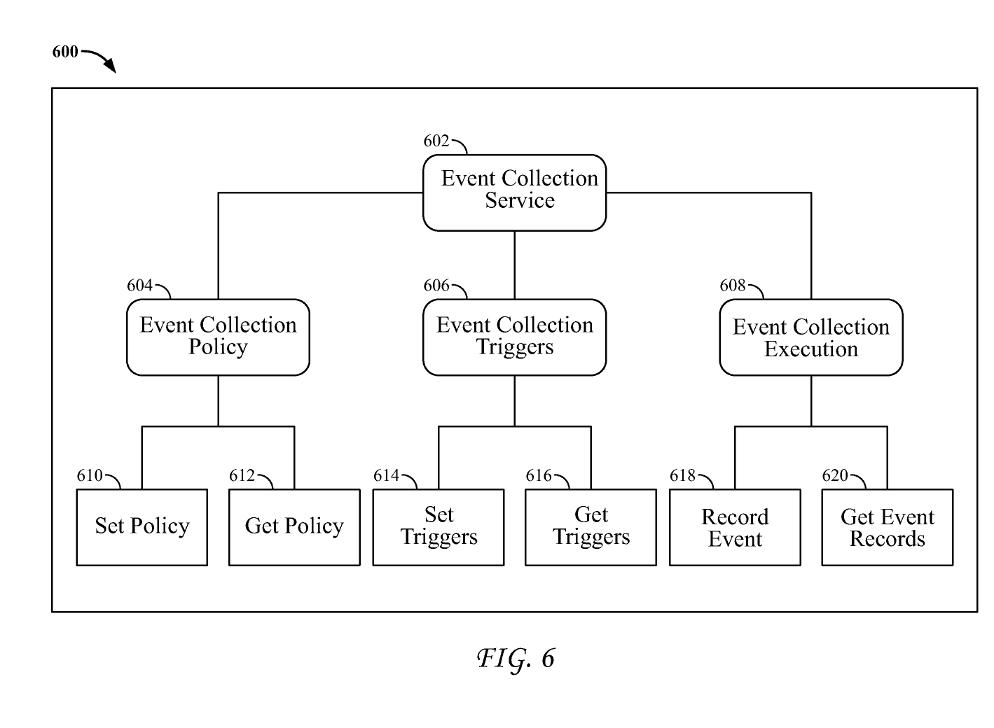

FIG. 5 is a diagram that illustrates a <statsCollect> resource 502 that can be used to collect information for AEs using the <eventConfig> resource 304 as the triggers for the IN-CSE. The IN-CSE may setup multiple triggers. Each trigger may be activated or de-activated independently of others. The <statsCollect> resource 502 can be located directly under <CSEBase> of IN-CSE.

The <statsCollect> resource can contain the child resource specified in table 7.

TABLE 7
Child resources of <statsCollect> resource

| Child Resources of | Child Resource | | |
|---|---|---|---|
| <statsCollect> | Type | Multiplicity | Description |
| [variable] | <subscription> | 0 . . . n | The <subscription> resource |
| | | | contains subscription information for |
| | | | its subscribed-to resource. The |
| | | | subscribed-to resource is the |
| | | | resource that has the <subscription> |
| | | | resource as the child resource. |

The <statsCollect> resource 502 can contain the attributes specified in table 8

TABLE 8
Attributes of <statsCollect> resource

| | | RW/ | |
|---|---|---|---|
| Attributes of | | RO/ | |
| <statsCollect> | Multiplicity | WO | Description |
| resourceType | 1 | RO | common attribute described at clause 9.6.1 of |
| | | | oneM2M functional architecture |
| resourceID | 1 | WO | common attribute described at clause 9.6.1 of |
| | | | oneM2M functional architecture |
| parentID | 1 | RO | common attribute described at clause 9.6.1 of |
| | | | oneM2M functional architecture |
| accessControlPolicy | 1 (L) | RW | common attribute described at clause 9.6.1 of |
| IDs | | | oneM2M functional architecture |
| | | | common attribute described at clause 9.6.1 of |
| | | | oneM2M functional architecture |
| creationTime | 1 | RO | common attribute described at clause 9.6.1 of |
| | | | oneM2M functional architecture |
| expirationTime | 1 | RW | common attribute described at clause 9.6.1 of |
| | | | oneM2M functional architecture |
| lastModifiedTime | 1 | RO | common attribute described at clause 9.6.1 of |
| | | | oneM2M functional architecture |
| labels | 0 . . . 1 | RW | common attribute described at clause 9.6.1 of |
| | | | oneM2M functional architecture |
| creator | 1 | RW | The AE-ID or CSE-ID of the entity which created |
| | | | the resource. |
| statsCollectID | 1 | RO | This is the unique ID to identify a specific |
| | | | statistics collection scenario. It is created by the |
| | | | IN-CSE when the <statsCollect> resource is first |
| | | | created. |
| collectingEntityID | 1 | WO | This is the unique ID of the entity that requests the |
| | | | collection of statistics. For example, it can be an |
| | | | AE-ID or CSE-ID. |
| collectedEntityID | 1 | WO | This is the unique ID of the entity whose |
| | | | operations at IN-CSE will be collected. For |
| | | | example, it can be an AE-ID or CSE-ID. If no |
| | | | specific value is provided for this attribute, the IN- |
| | | | CSE interprets it as “any entity”. |
| status | 1 | RW | This attribute indicates whether the rule is “active” |
| | | | or “inactive”. |
| statModel | 1 | RW | This attribute indicates the collection model, such |
| | | | as “Subscriber based”, “event based”, etc. |
| M2M-Sub-ID | 1 | WO | This attribute indicates the service subscription |
| | | | Identifier (M2M-Sub-ID) being recorded. |
| collectPeriod | 0 . . . 1 | RW | This attribute defines the duration to collect |
| | | | service statistics information. |
| eventID | 0 . . . 1 | RW | This attribute refers to the <eventConfig> |
| | | | resource that defines the events that can be |
| | | | collected by the IN-CSE. It is mandatory if the |
| | | | statmodel attribute is set to “event based”. |

### Service-Oriented Architecture (SOA) Event Collection Overview

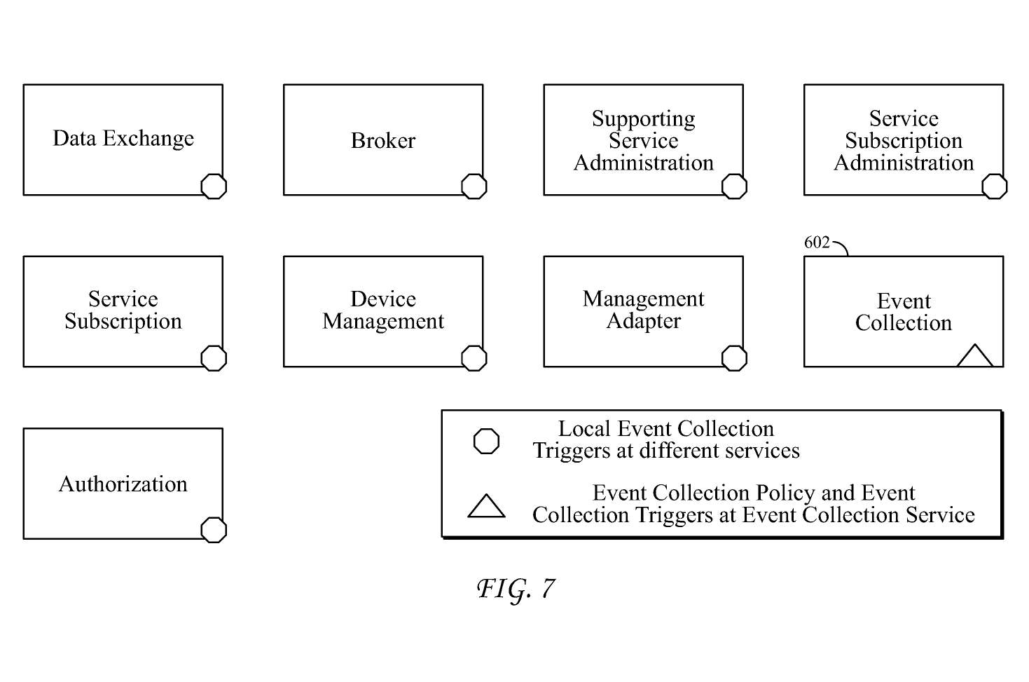

FIG. 6 is a diagram that illustrates a Service-Oriented Architecture (SOA) event collection architecture 600. The Event Collection Service 602 contains three logical functions: Event Collection Policy 604, Event Collection Triggers 606, and Event Collection Execution 608. These entities could reside on different nodes. For example, the Event Collection Policy 604 can be at the Infrastructure Node, and the Event Collection Execution 608 is usually at the node where the collectable event occurs. Each logical function can provide interfaces for AEs or CSEs to configure the event collection configuration, and/or obtain the configuration or event records. Which entity can access what information depends on the access right of the requesting entity.

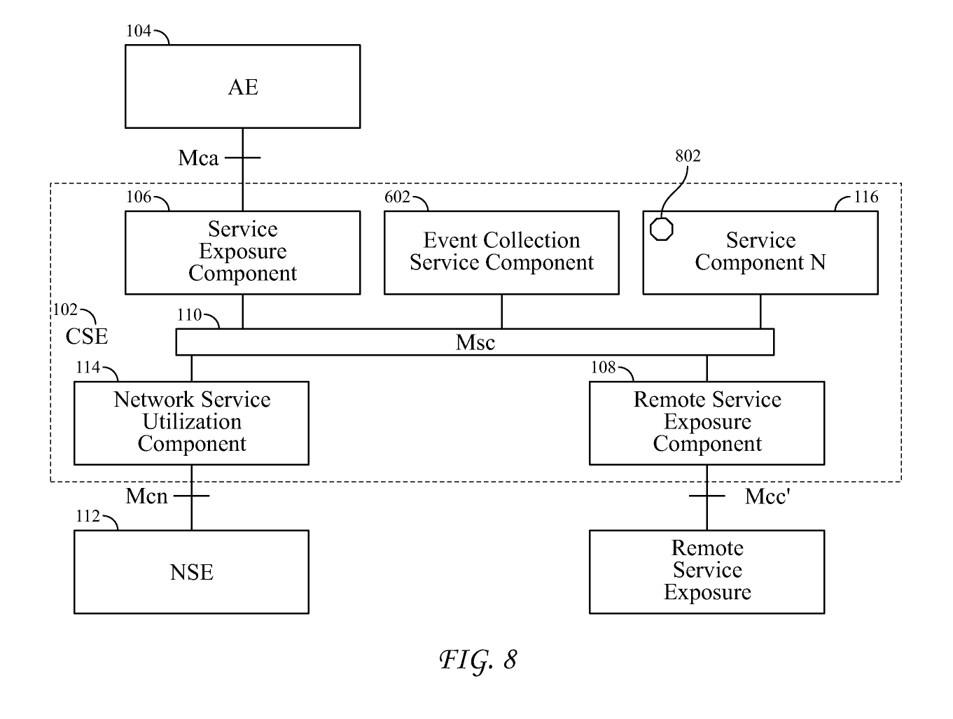

FIG. 7 is a diagram that illustrates how the event collection triggers can be distributed at different services. The Event Collection service entity 602 is where the policy and all triggers are defined and maintained (illustrated as triangles). The Event Collection service entity 702 can distribute the policy and triggers to other services, and the other services have a local policy or triggers, illustrated as hexagons, which is a sub-set of those contained at Event Collection.

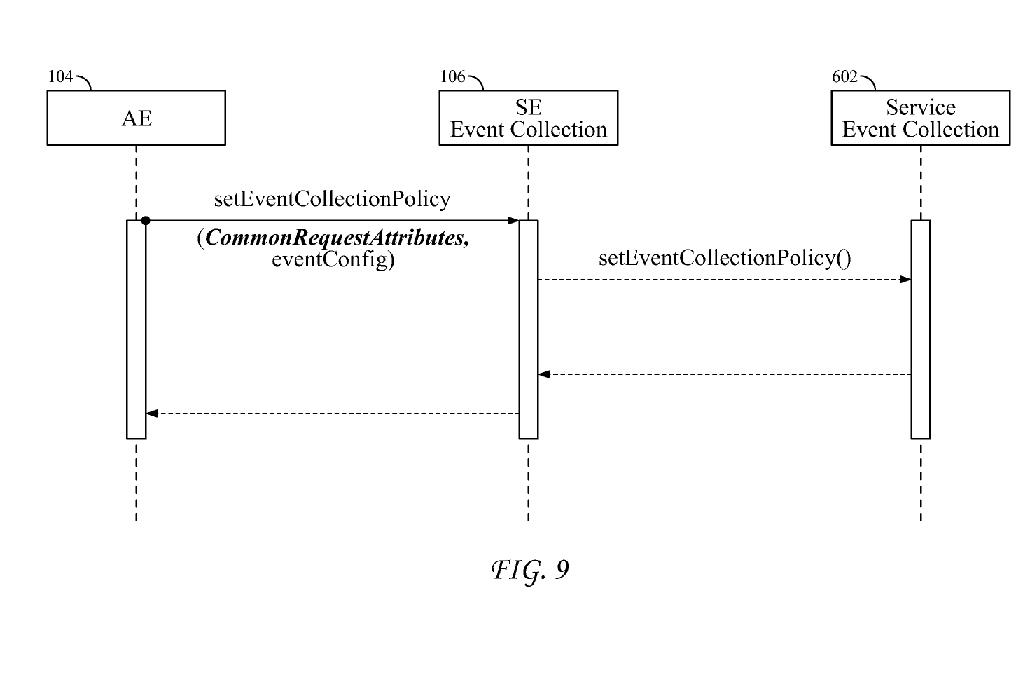

FIG. 8 is a diagram that illustrates the event collection service 602 as a service component in a oneM2M SOA Functional architecture. In this example, a local event trigger 802 is in the service component 116.

Looking again at FIG. 6, the Event Collection service 602 can provide the capability to record events for accounting purposes. The Service Capabilities can include setEventCollectionPolicy 610, getEventCollectionPolicy 612, setEventCollectionTriggers 614, getEventCollectionTriggers 616, getRecords 620 and recordEvent 618.

### Set Policy

The setEventCollectionPolicy service capability 610 provides the ability for AEs and CSEs to configure an event for statistics and charging purposes. The originator can be an AE or CSE that wants to configure event collection policies at a receiving CSE. The receiving CSE conducts event collection according to the policies. The receiving CSE may establish its own event collection policies. The originator, if different from the receiving CSE, is subscribed and registered to the receiving CSE.

The setEventCollectionPolicy signature of one embodiment is shown below. Table 9 shows setEventCollectionPolicy capability.

TABLE 9
Event Collection - setEventCollectionPolicy capability

| Parameter name | Direction | Optional | Description |
|---|---|---|---|
| commonParameters | IN | NO | See Table 1 |
| serviceId | IN | NO | The M2M Service Identifier (M2M-Serv-ID) |
| eventConfig | IN | NO | The configuration of the event collection policy |
| eventCollectionPolicyID | OUT | NO | The receiving CSE generates an unique policy ID |
| | | | for each policy. |
| responseType | OUT | YES | Unique response types for this service. |
| | | | Exception: Request may not have been |
| | | | completed |

Table 10 is a table of Event Collection—eventConfig Complex Data Types

TABLE 10
Event Collection - eventConfig Complex Data Type

| Parameter name | Optional | Description |
|---|---|---|
| eventType | NO | This attribute indicates the type of the event, such as |
| | | timer based, data operation, storage based, etc. The |
| | | eventType can be a combination of multiple sub-types, |
| | | for example, it can be based on both a data operation |
| | | and a timer, such as recording all RETRIEVE data |
| | | operation during 1 Hour period of time. |
| serviceRoleIds | YES | Defines the specific service role. |
| eventStart | YES | This attribute indicates the start time of the event. It is |
| | | mandatory if the eventType includes “timer based”. |
| eventEnd | YES | This attribute indicates the end time of the event. It is |
| | | mandatory if the eventType includes “timer based”. |
| operationType | YES | This attribute defines the type of the operation to be |
| | | collected by statistics, such as CREATE, RETRIEVE. |
| | | It is mandatory if the eventType includes “data |
| | | operation”. |
| dataSize | YES | This attribute defines the data size if an event is |
| | | triggered when the stored data exceeds a certain size. It |
| | | is mandatory if the eventType is “storage based”. |

Table 11 defines examples of eventType Complex Data Types. More events can be defined when more services are available.

TABLE 11
Event Collection - eventType Complex Data Type

| Parameter name | Optional | Description |
|---|---|---|
| subscribeComplete | YES | This attribute defines the event when the Data |
| | | Exchange entity completes the Subscribe service for a |
| | | service consumer, such as an AE. The event recording |
| | | shall be triggered when the Data Exchange service |
| | | received the subscribeComplete message. |
| publishComplete | YES | This attribute defines the event when the Data |
| | | Exchange entity completes the Publish service for a |
| | | service consumer, such as an AE. The event recording |
| | | shall be triggered when the Data Exchange service |
| | | received the publishComplete message. |
| notifyComplete | YES | This attribute defines the event when the Data |
| | | Exchange entity completes the Notify service for a |
| | | service consumer, such as an AE. The event recording |
| | | shall be triggered when the Data Exchange service |
| | | received the NotifyComplete message. |
| getServiceSubscriptionComplete | YES | This attribute defines the event when an entity, such as |
| | | an AE, retrieves the Service Subscription. The event |
| | | recording shall be triggered when the Service |
| | | Subscription Administration receives the |
| | | getServiceSubscriptionComplete message. |
| addDeviceToServiceSubscriptionComplete | YES | This attribute defines the event when an entity, such as |
| | | an AE, adds a device to a Service Subscription. The |
| | | event recording shall be triggered when the Service |
| | | Subscription Administration receives the |
| | | addDeviceToServiceSubscriptionComplete message. |
| deleteDeviceFromServiceSubscription | YES | This attribute defines the event when an entity, such as |
| | | an AE, deletes a device to a Service Subscription. The |
| | | event recording shall be triggered when the Service |
| | | Subscription Administration receives the |
| | | deleteDeviceToServiceSubscriptionComplete |
| | | message. |
| getDevicesForServiceSubscription | YES | This attribute defines the event when an entity, such as |
| | | an AE, retrieves a device from a Service Subscription. |
| | | The event recording shall be triggered when the |
| | | Service Subscription Administration receives the |
| | | getDevicesForServiceSubscriptionComplete message. |
| addApplicationsToServiceSubscription | YES | This attribute defines the event when an entity adds |
| | | M2M applications to a Service Subscription. The |
| | | event recording shall be triggered when the Service |
| | | Subscription Administration receives the |
| | | addApplicationsToServiceSubscriptionComplete |
| | | message. |

There need not be any Post-Conditions. With respect to exceptions, The originator has no access right to create the policy. Message Exchange Pattern can be In-Out. The interactions of service capabilities required for this service capability can include issuing the request to the Supporting Service to perform the operation.

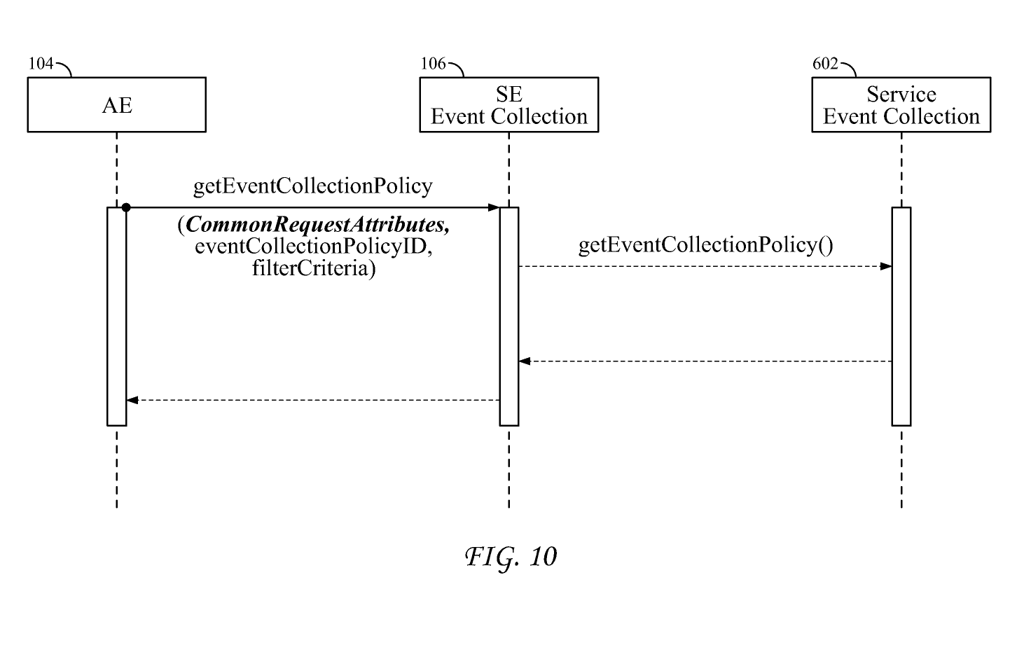

FIG. 9 is a flow chart that illustrates an exemplary setEventCollectionPolicy messaging. AE 104 (or CSE) sends a setEventCollectionPolicy message through Service Exposure Component 106 to Service event collection 602.

The setEventCollectionPolicy service capability 610 aligns with the <eventConfig> resource and maps to the CREATE procedure for the resource.

### Get Policy

The getEventCollectionPolicy service capability provides the ability for entities, such as an AE, to retrieve the existing policies at a CSE.

The originator can be an AE 104 or CSE that wants to retrieve event collection policies at a receiving CSE. The originator, if different from the receiving CSE, is subscribed and registered to the receiving CSE. The originator is only allowed to retrieve with the proper access right.

Table 12 shows the signature for the getEventCollectionPolicy service capability 612.

TABLE 12
Event Collection - getEventCollectionPolicy capability

| Parameter name | Direction | Optional | Description |
|---|---|---|---|
| commonParameters | IN | NO | See Table 1 |
| eventCollectionPolicyID | IN | NO | See Table 10 The eventCollectionPolicyID specifies |
| | | | the specific eventConfig to retrieve, if the originator |
| | | | has such information. If the originator does not have |
| | | | the information regarding |
| | | | eventCollectionPolicyIDs, it can indicate any event, |
| | | | and use the filterCriteria to filter selected events |
| filterCriteria | IN | YES | See Table 2 |
| responseType | OUT | YES | Unique response types for this service. |
| | | | Note: Consumed services also provide response |
| | | | types. |
| | | | Exception: Request may not have been |
| | | | completed |

In one embodiment, there are no Post-Conditions. With respect to exceptions, the originator has no access right to retrieve the policy. The Message Exchange Pattern can be In-Out. The interactions of service capabilities required for this service capability can include issuing the request to the Supporting Service to perform the operation.

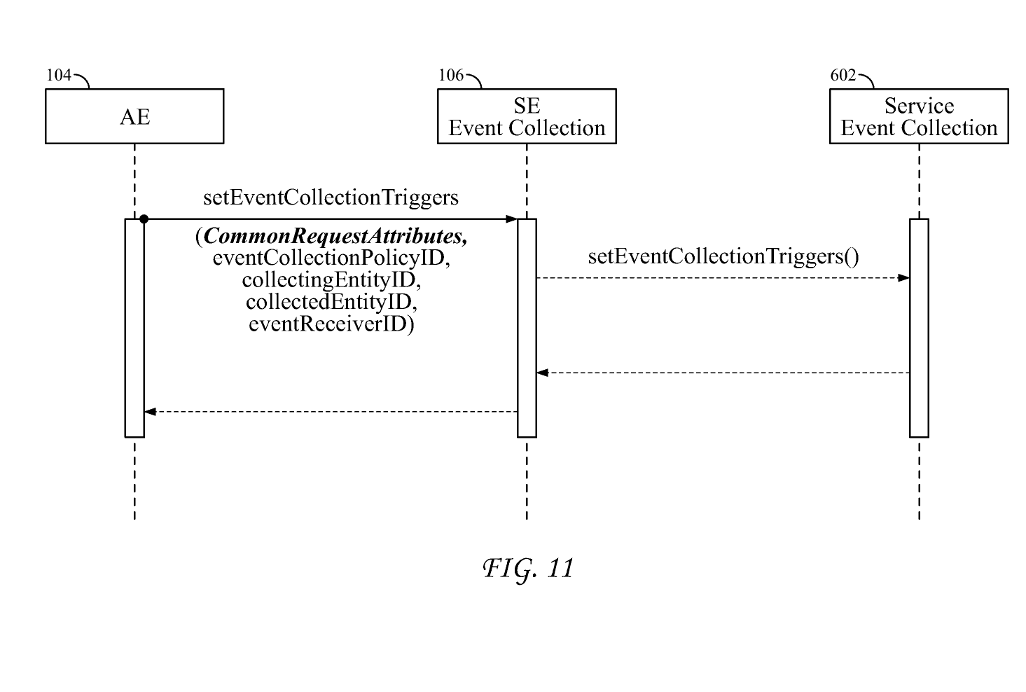

FIG. 10 is a flow chart that illustrates an exemplary getEventCollectionPolicy messaging. AE 104 (or CSE) sends a getEventCollectionPolicy message through Service Exposure Component 106 to Service event collection 602.

The getEventCollectionPolicy service capability 612 can align with the <eventConfig> resource and maps to the RETRIEVE procedure for the resource.

### Set Triggers

The setEventCollectionTriggers service capability 614 provides the ability for AEs 104 and CSEs to configure specific triggers for event collection, based on the Event Collection Policy.

The originator can be an AE or CSE that wants to configure event collection triggers based on existing event collection policy available at the collecting CSE.

Table 13 shows a Signature for the setEventCollectionTriggers service capacity 614.

TABLE 13
Event Collection - setEventCollectionTriggers capability

| Parameter name | Direction | Optional | Description |
|---|---|---|---|
| commonParameters | IN | NO | See Table 1 |
| eventCollectionPolicyID | IN | NO | This attribute specify the policy used to define the |
| | | | specific event collection trigger. |
| collectingEntityID | IN | YES | This is the ID of the entity where the event is being |
| | | | collected. If not specified, the default collecting |
| | | | entity is the receiving CSE. |
| collectedEntityID | IN | YES | This is the ID of the entity that triggered the event |
| | | | collection. If not specified, the default is all entities |
| | | | triggered the event at the collecting entity. |
| eventReceiverID | IN | YES | In cases when there is another entity, other than the |
| | | | collecting entity (such as a CSE), wants to receive |
| | | | the collected event, this attribute provides the |
| | | | unique ID of this entity. |
| serviceRoleIds | IN | YES | Specifies the service roles that trigger the event |
| | | | collection. |
| serviceId | IN | YES | Specifies the services that trigger the event |
| | | | collection. |
| triggerStatus | IN | YES | This attribute indicates if the trigger is activated or |
| | | | not. If not defined, the trigger is activated. |
| eventCollectionTriggerID | OUT | NO | The receiving CSE generates a unique ID for each |
| | | | event collection trigger. |
| responseType | OUT | YES | Unique response types for this service. |
| | | | Note: Consumed services also provide response |
| | | | types. |
| | | | Exception: Request may not have been |
| | | | completed |

With respect to Post-Conditions, after the successful creation of event collection triggers, when the defined event happens at the collectingEntity, and when the event collection trigger status is ACTIVE, the collectingEntity shall collect the event. The supporting service can send a recordEvent message to the Event Collection entity. With respect to Exceptions, The originator has no access right to create the event collection triggers. The Message Exchange Pattern can be In-Out

The interactions of service capabilities required for this service capability can include issuing the request to the Supporting Service to perform the operation.

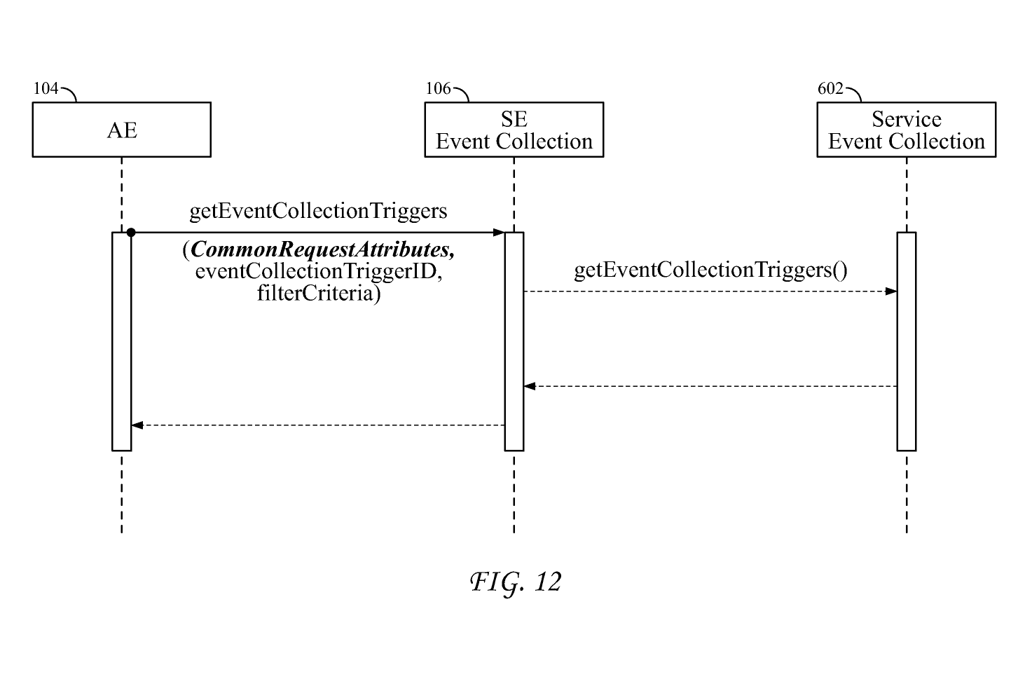

FIG. 11 is a flow chart that illustrates an exemplary setEventCollectionTriggers messaging. AE 104 (or CSE) sends a setEventCollectionTriggers message through Service Exposure Component 106 to Service event collection 602.

The setEventCollectionTriggers service capability 614 can align with the <statsCollect> resource and map to the CREATE procedure for the resource.

### Get Triggers

The getEventCollectionTriggers service capability 616 provides the ability for AEs 104 and CSEs to retrieve event collection triggers at a receiving CSE. Originating AEs 104 and CSEs are subscribed to the CSE and registered to the targeting CSE. Originator has the access right to retrieve.

Table 14 shows a signature for the getEventCollectionTriggers service capability 616.

TABLE 14
Event Collection - getEventCollectionTriggers capability

| Parameter name | Direction | Optional | Description |
|---|---|---|---|
| commonParameters | IN | NO | See Table 1 |
| eventCollectionTriggerID | IN | YES | This attribute specifies which event collection |
| | | | triggers to retrieve. If not specified, any event |
| | | | collection trigger matching the filter criteria should |
| | | | be retrieved. |
| filterCriteria | IN | YES | See Table 2 |
| responseType | OUT | YES | Unique response types for this service. |
| | | | Note: Consumed services also provide response |
| | | | types. |
| | | | Exception: Request may not have been |
| | | | completed |

In one embodiment, there are no Post-Conditions. With respect to exceptions, the originator has no access right to retrieve the event collection triggers. The Message Exchange Pattern can be In-Out. The interactions of service capabilities required for this service capability can include issuing the request to the Supporting Service to perform the operation.

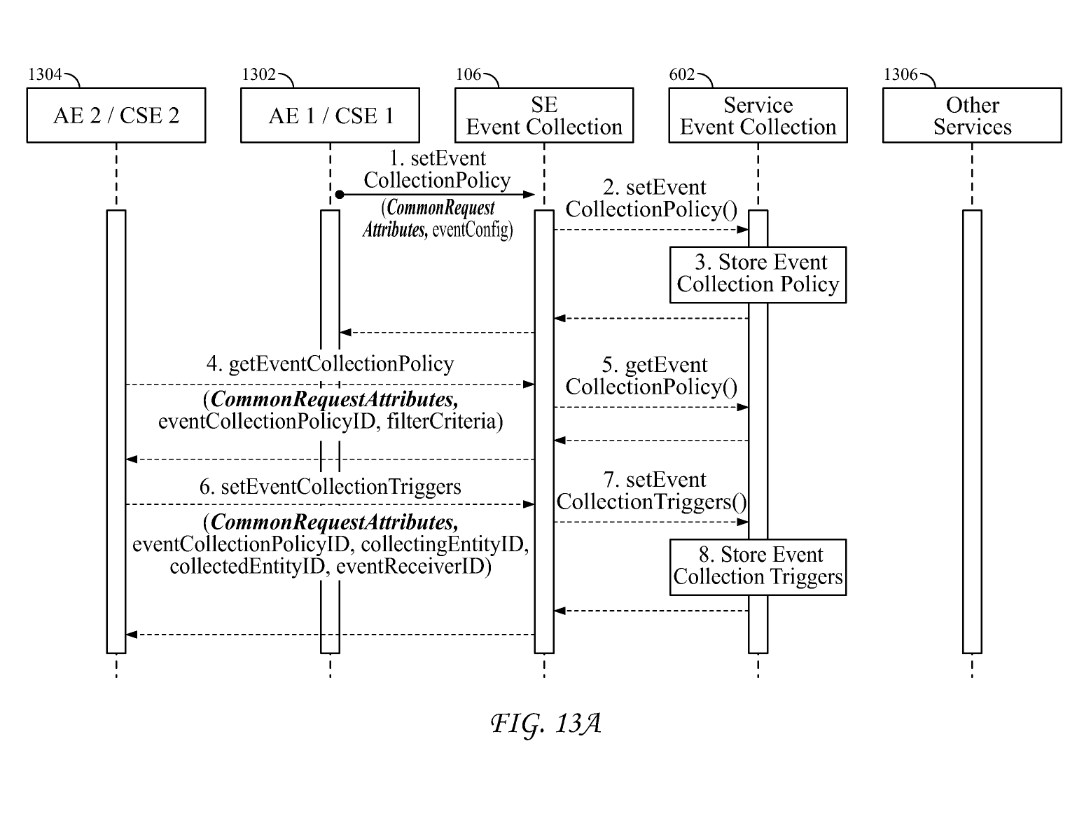

FIG. 12 is a flow chart that illustrates an exemplary getEventCollectionTriggers messaging. AE 104 (or CSE) sends a getEventCollectionTriggers message through Service Exposure Component 106 to service event collection 602.

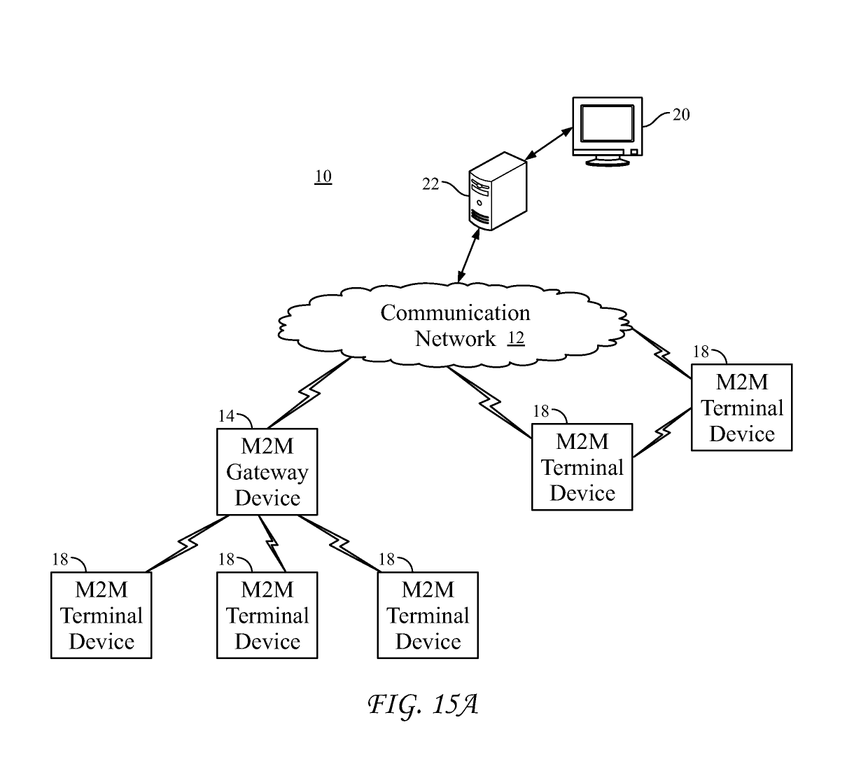

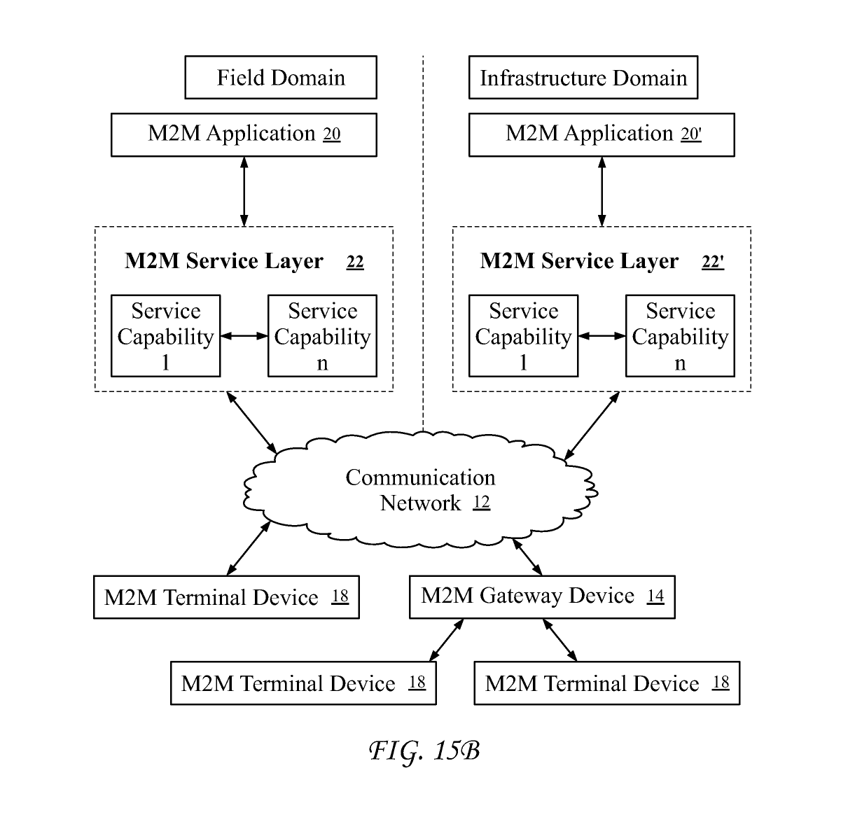

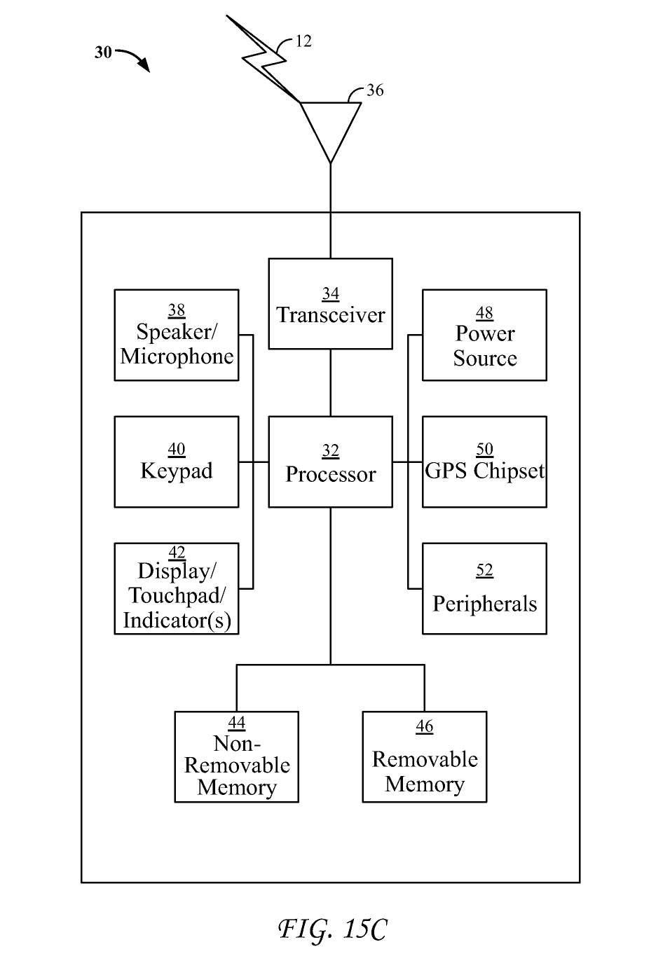

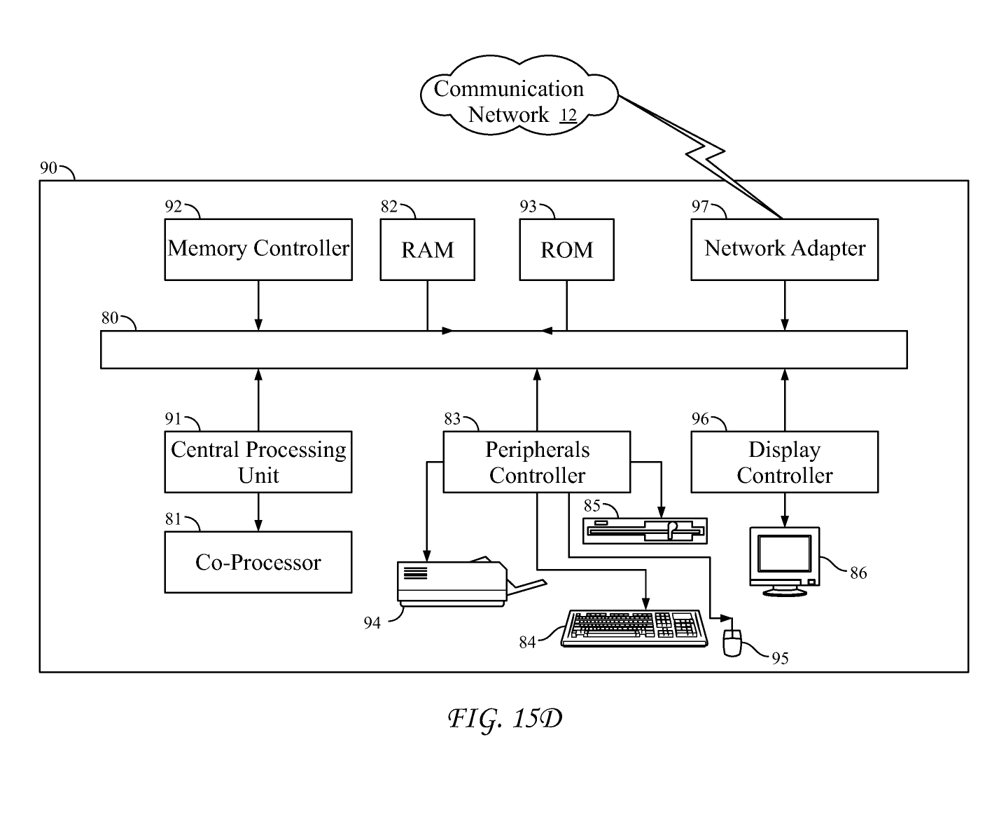

It is understood that the entities performing the steps illustrated in FIGS. 9-12 are logical entities that may be implemented in the form of software (i.e., computer-executable instructions) stored in a memory of, and executing on a processor of, a network node or computer system such as those illustrated in FIG. 15C or FIG. 15D. That is, the method(s) illustrated in FIGS. 9-12 may be implemented in the form of software (i.e., computer-executable instructions) stored in a memory of a network node, such as the node or computer system illustrated in FIG. 15C or FIG. 15D, which computer executable instructions, when executed by a processor of the node, perform the steps illustrated in FIGS. 9-12.

The getEventCollectionTriggers service capability 616 can align with the <statsCollect> resource and map to the RETRIEVE procedure for the resource.

### Record Event

The recordEvent service capability 618 can provides the ability for a service (such as Data Exchange service) to trigger the collecting entity (such as a CSE) to record an event. In one embodiment, the Pre-conditions include the Event Collection Triggers have been created by the setEventCollectionTriggers capability 614.

Table 15 show a signature for the recordEvent service capability 618.

TABLE 15
Event Collection - recordEvent capability

| Parameter name | Direction | Optional | Description |
|---|---|---|---|
| commonParameters | IN | NO | See Table 1 |
| eventCollectionPolicyID | IN | YES | This attribute specify the policy used to define the |
| | | | specific event collection trigger. |
| collectingEntityID | IN | YES | This is the ID of the entity where the event is being |
| | | | collected. If not specified, the default collecting |
| | | | entity is the receiving CSE. |
| collectedEntityID | IN | YES | This is the ID of the entity that triggered the event |
| | | | collection. If not specified, the default is all entities |
| | | | triggered the event at the collecting entity. |
| eventCollectionTriggerID | IN | NO | The service where the trigger happens provides the |
| | | | eventCollectionTriggerID being used. |
| eventDescription | IN | NO | This attribute describes the event triggered at the |
| | | | service. It is a subset of the eventConfig data |
| | | | structure. The specific structure depends on the |
| | | | specific event defined by the |
| | | | eventCollectionTriggerID. |
| responseType | OUT | YES | Unique response types for this service. |
| | | | Note: Consumed services also provide response |
| | | | types. |
| | | | Exception: Request may not have been |
| | | | completed |

In one embodiment, there are no Post-Conditions or exceptions. The Message Exchange Pattern can be In-Out. The interactions of service capabilities required for this service capability can include the request coming from the service where the event was triggered to the Event Collection entity 602.

### Get Event Records

The getRecords service capability 620 provides the ability for AEs and CSEs to retrieve the recorded events for statistical or charging purposes. The Pre-conditions can include the originating AEs and CSEs are subscribed to the CSE and registered to the receiving CSE.

Table 16 shows a signature of the getRecords service capability 620.

TABLE 16
Event Collection - getRecords capability

| Parameter name | Direction | Optional | Description |
|---|---|---|---|
| commonParameters | IN | NO | See Table 1 |
| filterCriteria | IN | YES | See Table 2 |
| responseType | OUT | YES | Unique response types for |
| | | | this service. |
| | | | Note: Consumed services |
| | | | also provide response |
| | | | types. |
| | | | Exception: Request may not |
| | | | have been completed |

In one embodiment, there are no Post-Conditions or exceptions. The Message Exchange Pattern can be In-Out. The interactions of service capabilities required for this service capability can include the originator sending the request to the Event Collection entity to obtain the event records it is interested in.

Table 17 is a table of an exemplary Event Record Template.

TABLE 17
Event Record Template

| Information Element | Optional | Description |
|---|---|---|
| eventRecordID | NO | It is the unique ID that identifies a specific event |
| | | record. |
| eventCollectionTriggerID | | It is the unique ID that identifies a specific event |
| | | collection triggering scenario, which triggers |
| | | information recording for a specific event. |
| collectingEntityID | NO | This is the unique ID of the entity that collects the |
| | | statistics. It can be an AE-ID or CSE-ID |
| collectedEntityID | NO | This is the unique ID of the entity whose service |
| | | layer operation statistics are being collected. It can |
| | | be an AE-ID or CSE-ID. |
| subscriberID | YES | The M2M service subscription ID M2M-Sub-ID if |
| | | the collected entity |
| eventDescription | NO | describes the event triggered at the service. It is a |
| | | subset of the eventConfig data structure. The |
| | | specific structure depends on the specific event |
| | | defined by the eventCollectionTriggerID. |
| Vendor Specific | YES | Defines Vendor specific information |
| Information | | |

### Use of Event Collection Service

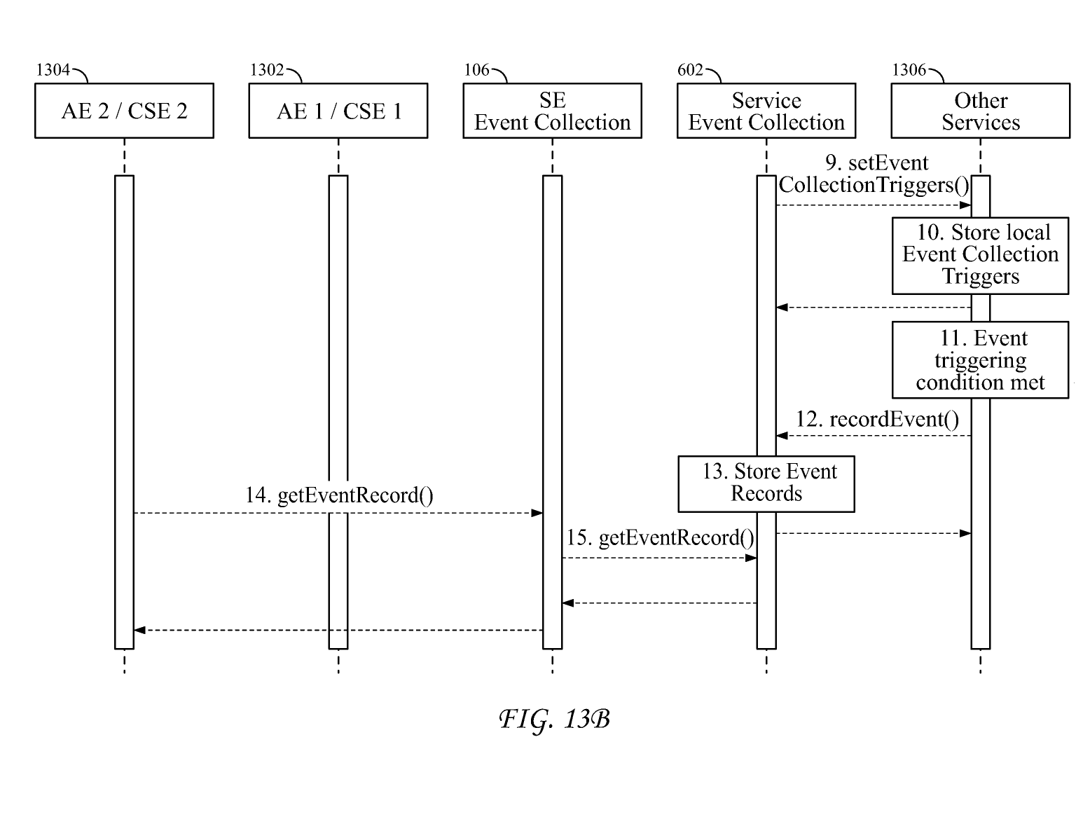

FIGS. 13A and 13B are diagrams that show an exemplary sequence of event collection. For readability, the operations are divided by two parts: FIG. 13A illustrates the configuration of event collection policy and event triggers, and FIG. 13B illustrates the event collection when trigger occurs.

In steps 1-3 of FIG. 13A, AE or CSE 1302 (identified as AE1 or CSE1) configures event collection policy at the Service Exposure. The Service Exposure Entity 106 passes the message to the Event Collection Service 602. The message contains the information element of “eventConfig” as defined previously in this document. The policy is stored at the Event Collection service entity.

In steps 4-5 of FIG. 13A, another AE or CSE 1304 (identified as AE2 or CSE2) can retrieve the event collection policy available for discovery.

In steps 6-8 of FIG. 13A, AE2 or CSE2 1304 configures event collection triggers based on the event collection policy it obtained. Such triggers are stored at the Event Collection Entity 602.

In steps 9-10 of FIG. 13B, the Event Collection Service Entity 602 passes the event collection triggers to the appropriate services 1306, such as Data Exchange service. The services 1306 store a local version of the triggers.

In steps 11-13 of FIG. 13B, when the conditions of the configured event happen, the other services generate the event and request the Event Collection entity 602 to record the event. For example, when the Data Exchange service receives the subscribeComplete message, it triggers the recordEvent message and sends it to the Event Collection service entity 602. The Event Collection service entity 602 stores event records.

In steps 14-15 of FIG. 13B, AE2 or CSE2 1304 obtains the event records from the Event Collection service entity 602. For example, it can obtain all events related to itself for a period of time.

Although the specification above discloses a pull model with get methods getEventCollectionPolicy 612, getEventCollectionTriggers 616, and getRecords 620, it is to be understood that a push model can be used. For example, in a push model, the Event Collection Service Entity 602 can push event records to the requesting AE or CSE.

It is understood that the entities performing the steps illustrated in FIG. 13A-B are logical entities that may be implemented in the form of software (i.e., computer-executable instructions) stored in a memory of, and executing on a processor of, a network node or computer system such as those illustrated in FIG. 15C or FIG. 15D. That is, the method(s) illustrated in FIG. 13A-B may be implemented in the form of software (i.e., computer-executable instructions) stored in a memory of a network node, such as the node or computer system illustrated in FIG. 15C or FIG. 15D, which computer executable instructions, when executed by a processor of the node, perform the steps illustrated in FIG. 13A-B.

An exemplary use of the present application concerns a Service Provider with a billing application. The billing application (such as AE1) can set up the event collection policy at a CSE which resides at the M2M server. The M2M server may push the policies to the gateways connected to it, or a gateway may query the policy from the server. Another application AE2 is a weather system app and the weather data is stored at the M2M server. It retrieves the policy for a “event collection for every RETRIEVE operation” from the M2M server, and sets up its own trigger as “AE1 collects trigger of RETRIEVE from all entities” at the M2M server. In this example, the M2M server will perform event recording for AE2 every time when the trigger condition is met. The M2M server will generate the event records and the AE2 can get it. Then, AE2 can bill the users who used its weather data.

The following describes a list of M2M Services as well as the list of associated roles mapped to each M2M Service. Table 18 includes a list of M2M services. The added Event Collection service is shown in the last row of the table.

TABLE 18
M2M Services

| | M2M- | |
|---|---|---|
| M2M Service (name) | Serv-ID | Roles |
| Application and service | 01 | 001—Software management |
| management | | |
| Device management | 02 | 002—Device Configuration |
| | | 003—Device Diagnostics and |
| | | Monitoring |
| | | 004—Device Firmware Management |
| | | 005—Device Topology |
| Location | 03 | 006—Location |
| Data exchange | 04 | 007—Basic data |
| Device onboarding | 05 | 008—onboarding |
| Security | 06 | 009—Security Administration |
| Event Collection | 07 | 010—Event Collection |

Use of M2M Service Subscription across M2M Service Provider domains is subject to M2M Service Providers agreement.

Table 19 provides an example of mapping of Service Roles to resource types and operations. The added Event Collection service is shown in the last row of the table. Such a table is to be configured by the SP to allow for the validation of requests according to the service subscription.

TABLE 19
Mapping of Service Roles to Resource Types/Allowed Operations

| ServiceRole | Resource Type/Allowed Operations |
|---|---|
| 001: Software management | mgmtObj/CRUD |
| | mgmtCmd/CRUD |
| | software/CRUD |
| 002: Device Configuration | mgmtObj/CRUD |
| | mgmtCmd/CRUD |
| | deviceInfo/CRUD |
| 003: Device Diagnostics and | mgmtObj/CRUD |
| Monitoring | mgmtCmd/CRUD |
| | deviceInfo/CRUD |
| | deviceCapability/CRUD |
| 004: Device Firmware | mgmtObj/CRUD |
| Management | mgmtCmd/CRUD |
| | firmware/CRUD |
| 005: Device Topology | mgmtObj/CRUD |
| | mgmtCmd/CRUD |
| | areaNwkInfo/CRUD |
| | areaNwkDeviceInfo/CRUD |
| 006: Location | locationPolicy/CRUD |
| | container/CRUD |
| | subscription/CRUD |
| 007: Basic data | container/CRUD |
| | subscription/CRUD |
| 008: onboarding | m2mServiceSubscriptionProfile/ |
| | CRUD |
| | serviceSubscribedNode/CRUD |
| 009: Security Administration | accessControlPolicy/CRUD |
| 0010: Event Collection | statsConfig/CRUD |
| | eventConfig/CRUD |
| | statsCollect/CRUD |

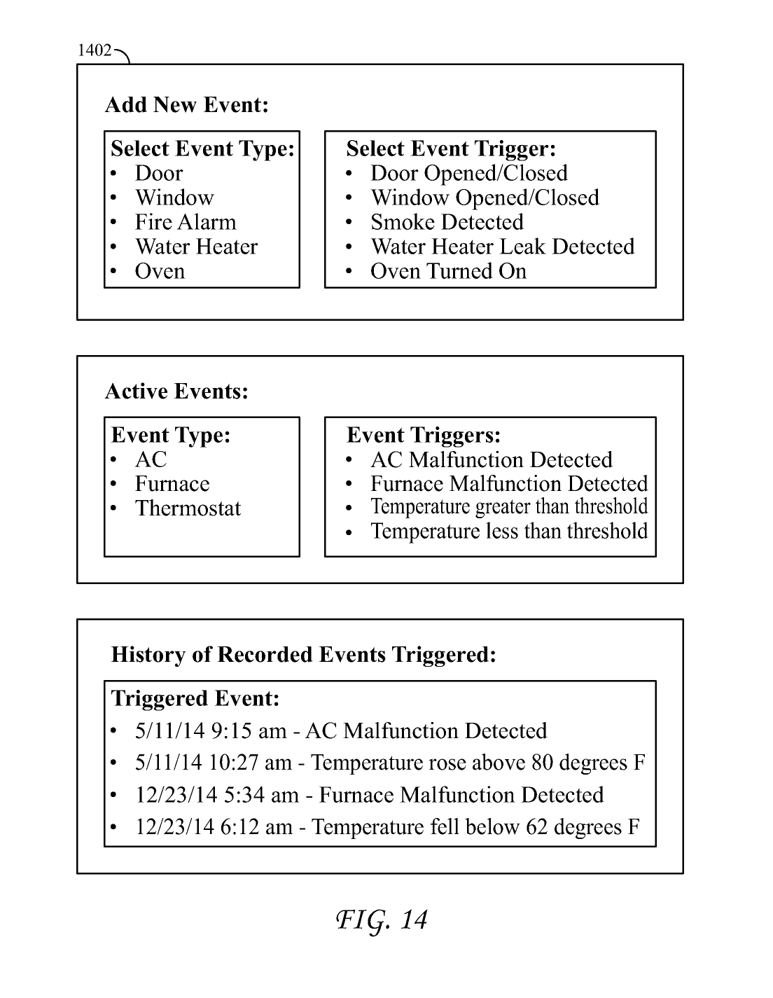

Interfaces, such as Graphical User Interfaces (GUIs), can be used to assist user to control and/or configure functionalities related to a scalable charging system based on SOA. FIG. 14 is a diagram that illustrates an interface 1402 that allows a user to configure service layer event detection policies and event detection triggers. The interface 1402 can also be used to allow the user to observe events recorded by the service layer if/when an event trigger occurs. It is to be understood that interface 1402 can be produced using displays such as those shown in FIGS. 15C-D described below.

### Example M2M/IoT/WoT Communication System

FIG. 15A is a diagram of an example machine-to machine (M2M), Internet of Things (IoT), or Web of Things (WoT) communication system 10 in which one or more disclosed embodiments may be implemented. Generally, M2M technologies provide building blocks for the IoT/WoT, and any M2M device, M2M gateway, M2M server, or M2M service platform may be a component or node of the IoT/WoT as well as an IoT/WoT service layer, etc. Communication system 10 can be used to implement functionality of the disclosed embodiments and can include functionality and logical entities such as Event Collection Service 602, Event Collection Policy 604, Event Collection Triggers 606 Event Collection Execution 608, Set Policy 610, Get Policy 612, Set Triggers 614, Get Triggers 616, Record Event 618, Get Event Record 620, Triggers 802, AE 104 1302 and 1304, Service Exposure Component 106, Service Component 115 and 116, Network Service Utilization Component 114, Remote Service Exposure Component 108, CSE 102 1302 and 1304, NSE 112 and services 1306 and logical entities to produce GUIs such as GUI 1402.

As shown in FIG. 15A, the M2M/IoT/WoT communication system 10 includes a communication network 12. The communication network 12 may be a fixed network (e.g., Ethernet, Fiber, ISDN, PLC, or the like) or a wireless network (e.g., WLAN, cellular, or the like) or a network of heterogeneous networks. For example, the communication network 12 may be comprised of multiple access networks that provide content such as voice, data, video, messaging, broadcast, or the like to multiple users. For example, the communication network 12 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. Further, the communication network 12 may comprise other networks such as a core network, the Internet, a sensor network, an industrial control network, a personal area network, a fused personal network, a satellite network, a home network, or an enterprise network for example.

As shown in FIG. 15A, the M2M/IoT/WoT communication system 10 may include the Infrastructure Domain and the Field Domain. The Infrastructure Domain refers to the network side of the end-to-end M2M deployment, and the Field Domain refers to the area networks, usually behind an M2M gateway. The Field Domain and Infrastructure Domain may both comprise a variety of different network nodes (e.g., servers, gateways, device, and the like). For example, the Field Domain may include M2M gateways 14 and terminal devices 18. It will be appreciated that any number of M2M gateway devices 14 and M2M terminal devices 18 may be included in the M2M/IoT/WoT communication system 10 as desired. Each of the M2M gateway devices 14 and M2M terminal devices 18 are configured to transmit and receive signals, using communications circuitry, via the communication network 12 or direct radio link. A M2M gateway 14 allows wireless M2M devices (e.g. cellular and non-cellular) as well as fixed network M2M devices (e.g., PLC) to communicate either through operator networks, such as the communication network 12 or direct radio link. For example, the M2M terminal devices 18 may collect data and send the data, via the communication network 12 or direct radio link, to an M2M application 20 or other M2M devices 18. The M2M terminal devices 18 may also receive data from the M2M application 20 or an M2M terminal device 18. Further, data and signals may be sent to and received from the M2M application 20 via an M2M service layer 22, as described below. M2M terminal devices 18 and gateways 14 may communicate via various networks including, cellular, WLAN, WPAN (e.g., Zigbee, 6LoWPAN, Bluetooth), direct radio link, and wireline for example.

Exemplary M2M terminal devices 18 include, but are not limited to, tablets, smart phones, medical devices, temperature and weather monitors, connected cars, smart meters, game consoles, personal digital assistants, health and fitness monitors, lights, thermostats, appliances, garage doors and other actuator-based devices, security devices, and smart outlets.

Referring to FIG. 15B, the illustrated M2M service layer 22 in the field domain provides services for the M2M application 20, M2M gateway devices 14, and M2M terminal devices 18 and the communication network 12. Communication network 12 can be used to implement functionality of the disclosed embodiments and can include functionality and logical entities such as Event Collection Service 602, Event Collection Policy 604, Event Collection Triggers 606 Event Collection Execution 608, Set Policy 610, Get Policy 612, Set Triggers 614, Get Triggers 616, Record Event 618, Get Event Record 620, Triggers 802, AE 104 1302 and 1304, Service Exposure Component 106, Service Component 115 and 116, Network Service Utilization Component 114, Remote Service Exposure Component 108, CSE 102 1302 and 1304, NSE 112 and services 1306 and logical entities to produce GUIs such as GUI 1402. The M2M service layer 22 may be implemented by one or more servers, computers, devices, virtual machines (e.g. cloud/storage farms, etc.) or the like, including for example the devices illustrated in FIGS. 15C and 15D described below. It will be understood that the M2M service layer 22 may communicate with any number of M2M applications, M2M gateways 14, M2M terminal devices 18, and communication networks 12 as desired. The M2M service layer 22 may be implemented by one or more nodes of the network, which may comprises servers, computers, devices, or the like. The M2M service layer 22 provides service capabilities that apply to M2M terminal devices 18, M2M gateways 14, and M2M applications 20. The functions of the M2M service layer 22 may be implemented in a variety of ways, for example as a web server, in the cellular core network, in the cloud, etc.

Similar to the illustrated M2M service layer 22, there is the M2M service layer 22′ in the Infrastructure Domain. M2M service layer 22′ provides services for the M2M application 20′ and the underlying communication network 12′ in the infrastructure domain. M2M service layer 22′ also provides services for the M2M gateways 14 and M2M terminal devices 18 in the field domain. It will be understood that the M2M service layer 22′ may communicate with any number of M2M applications, M2M gateways and M2M devices. The M2M service layer 22′ may interact with a service layer by a different service provider. The M2M service layer 22′ by one or more nodes of the network, which may comprises servers, computers, devices, virtual machines (e.g., cloud computing/storage farms, etc.) or the like.

Referring also to FIG. 15B, the M2M service layers 22 and 22′ provide a core set of service delivery capabilities that diverse applications and verticals can leverage. These service capabilities enable M2M applications 20 and 20′ to interact with devices and perform functions such as data collection, data analysis, device management, security, billing, service/device discovery etc. Essentially, these service capabilities free the applications of the burden of implementing these functionalities, thus simplifying application development and reducing cost and time to market. The service layers 22 and 22′ also enable M2M applications 20 and 20′ to communicate through various networks 12 and 12′ in connection with the services that the service layers 22 and 22′ provide.

The methods of the present application may be implemented as part of a service layer 22 and 22′. The service layer 22 and 22′ is a software middleware layer that supports value-added service capabilities through a set of Application Programming Interfaces (APIs) and underlying networking interfaces. Both ETSI M2M and oneM2M use a service layer that may contain the connection methods of the present application. ETSI M2M's service layer is referred to as the Service Capability Layer (SCL). The SCL may be implemented within an M2M device (where it is referred to as a device SCL (DSCL)), a gateway (where it is referred to as a gateway SCL (GSCL)) and/or a network node (where it is referred to as a network SCL (NSCL)). The oneM2M service layer supports a set of Common Service Functions (CSFs) (i.e. service capabilities). An instantiation of a set of one or more particular types of CSFs is referred to as a Common Services Entity (CSE) which can be hosted on different types of network nodes (e.g. infrastructure node, middle node, application-specific node). Further, connection methods of the present application can implemented as part of an M2M network that uses a Service Oriented Architecture (SOA) and/or a resource-oriented architecture (ROA) to access services such as the connection methods of the present application.

In some embodiments, M2M applications 20 and 20′ may be used in conjunction with the disclosed systems and methods. The M2M applications 20 and 20′ may include the applications that interact with the UE or gateway and may also be used in conjunction with other disclosed systems and methods.

In one embodiment, the logical entities such as Event Collection Service 602, Event Collection Policy 604, Event Collection Triggers 606 Event Collection Execution 608, Set Policy 610, Get Policy 612, Set Triggers 614, Get Triggers 616, Record Event 618, Get Event Record 620, Triggers 802, AE 104 1302 and 1304, Service Exposure Component 106, Service Component 115 and 116, Network Service Utilization Component 114, Remote Service Exposure Component 108, CSE 102 1302 and 1304, NSE 112 and services 1306 and logical entities to produce GUIs such as GUI 1402 may be hosted within a M2M service layer instance hosted by an M2M node, such as an M2M server, M2M gateway, or M2M device, as shown in FIG. 15B. For example, the logical entities such as Event Collection Service 602, Event Collection Policy 604, Event Collection Triggers 606 Event Collection Execution 608, Set Policy 610, Get Policy 612, Set Triggers 614, Get Triggers 616, Record Event 618, Get Event Record 620, Triggers 802, AE 104 1302 and 1304, Service Exposure Component 106, Service Component 115 and 116, Network Service Utilization Component 114, Remote Service Exposure Component 108, CSE 102 1302 and 1304, NSE 112 and services 1306 and logical entities to produce GUIs such as GUI 1402 may comprise an individual service capability within the M2M service layer instance or as a sub-function within an existing service capability.

The M2M applications 20 and 20′ may include applications in various industries such as, without limitation, transportation, health and wellness, connected home, energy management, asset tracking, and security and surveillance. As mentioned above, the M2M service layer, running across the devices, gateways, servers and other nodes of the system, supports functions such as, for example, data collection, device management, security, billing, location tracking/geofencing, device/service discovery, and legacy systems integration, and provides these functions as services to the M2M applications 20 and 20′.

Generally, the service layers 22 and 22′ define a software middleware layer that supports value-added service capabilities through a set of Application Programming Interfaces (APIs) and underlying networking interfaces. Both the ETSI M2M and oneM2M architectures define a service layer. ETSI M2M's service layer is referred to as the Service Capability Layer (SCL). The SCL may be implemented in a variety of different nodes of the ETSI M2M architecture. For example, an instance of the service layer may be implemented within an M2M device (where it is referred to as a device SCL (DSCL)), a gateway (where it is referred to as a gateway SCL (GSCL)) and/or a network node (where it is referred to as a network SCL (NSCL)). The oneM2M service layer supports a set of Common Service Functions (CSFs) (i.e., service capabilities). An instantiation of a set of one or more particular types of CSFs is referred to as a Common Services Entity (CSE) which can be hosted on different types of network nodes (e.g. infrastructure node, middle node, application-specific node). The Third Generation Partnership Project (3GPP) has also defined an architecture for machine-type communications (MTC). In that architecture, the service layer, and the service capabilities it provides, are implemented as part of a Service Capability Server (SCS). Whether embodied in a DSCL, GSCL, or NSCL of the ETSI M2M architecture, in a Service Capability Server (SCS) of the 3GPP MTC architecture, in a CSF or CSE of the oneM2M architecture, or in some other node of a network, an instance of the service layer may be implemented as a logical entity (e.g., software, computer-executable instructions, and the like) executing either on one or more standalone nodes in the network, including servers, computers, and other computing devices or nodes, or as part of one or more existing nodes. As an example, an instance of a service layer or component thereof may be implemented in the form of software running on a network node (e.g., server, computer, gateway, device or the like) having the general architecture illustrated in FIG. 15C or FIG. 15D described below.

Further, logical entities such as Event Collection Service 602, Event Collection Policy 604, Event Collection Triggers 606 Event Collection Execution 608, Set Policy 610, Get Policy 612, Set Triggers 614, Get Triggers 616, Record Event 618, Get Event Record 620, Triggers 802, AE 104 1302 and 1304, Service Exposure Component 106, Service Component 115 and 116, Network Service Utilization Component 114, Remote Service Exposure Component 108, CSE 102 1302 and 1304, NSE 112 and services 1306 and logical entities to produce GUIs such as GUI 1402 can implemented as part of an M2M network that uses a Service Oriented Architecture (SOA) and/or a Resource-Oriented Architecture (ROA) to access services of the present application.

FIG. 15C is a block diagram of an example hardware/software architecture of a M2M network node 30, such as an M2M device 18, an M2M gateway 14, an M2M server, or the like. The node 30 can execute or include logical entities such as Event Collection Service 602, Event Collection Policy 604, Event Collection Triggers 606 Event Collection Execution 608, Set Policy 610, Get Policy 612, Set Triggers 614, Get Triggers 616, Record Event 618, Get Event Record 620, Triggers 802, AE 104 1302 and 1304, Service Exposure Component 106, Service Component 115 and 116, Network Service Utilization Component 114, Remote Service Exposure Component 108, CSE 102 1302 and 1304, NSE 112 and services 1306 and logical entities to produce GUIs such as GUI 1402. The device 30 can be part of an M2M network as shown in FIG. 15A-B or part of a non-M2M network. As shown in FIG. 15C, the M2M node 30 may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The node 30 may also include communication circuitry, such as a transceiver 34 and a transmit/receive element 36. It will be appreciated that the M2M node 30 may include any sub-combination of the foregoing elements while remaining consistent with an embodiment. This node may be a node that implements the SMSF functionality described herein.

The processor 32 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node in order to perform the various required functions of the node. For example, the processor 32 may perform signal coding, data processing, power control, input/output processing, and/or any other functionality that enables the M2M node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

As shown in FIG. 15C, the processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected. In particular, the processor 32 may control the communication circuitry in order to perform the transmitting and receiving steps described herein and in the claims. While FIG. 15C depicts the processor 32 and the transceiver 34 as separate components, it will be appreciated that the processor 32 and the transceiver 34 may be integrated together in an electronic package or chip.

The transmit/receive element 36 may be configured to transmit signals to, or receive signals from, other M2M nodes, including M2M servers, gateways, device, and the like. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 15C as a single element, the M2M node 30 may include any number of transmit/receive elements 36. More specifically, the M2M node 30 may employ MIMO technology. Thus, in an embodiment, the M2M node 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the M2M node 30 may have multi-mode capabilities. Thus, the transceiver 34 may include multiple transceivers for enabling the M2M node 30 to communicate via multiple RATs, such as UTRA and IEEE 802.11, for example.

The processor 32 may access information from, and store data in, any type of suitable memory, such as the non-removable memory 44 and/or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the M2M node 30, such as on a server or a home computer. The processor 32 may be configured to control lighting patterns, images, or colors on the display or indicators 42 to reflect the status of an M2M service layer session migration or sharing or to obtain input from a user or display information to a user about the node's session migration or sharing capabilities or settings. In another example, the display may show information with regard to a session state. The current disclosure defines a RESTful user/application API in the oneM2M embodiment. A graphical user interface, which may be shown on the display, may be layered on top of the API to allow a user to interactively establish and manage an E2E session, or the migration or sharing thereof, via the underlying service layer session functionality described herein.

The processor 32 may receive power from the power source 48, and may be configured to distribute and/or control the power to the other components in the M2M node 30. The power source 48 may be any suitable device for powering the M2M node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the M2M node 30. It will be appreciated that the M2M node 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include an accelerometer, an e-compass, a satellite transceiver, a sensor, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 15D is a block diagram of an exemplary computing system 90 which may also be used to implement one or more nodes of an M2M network, such as an M2M server, gateway, device, or other node. Computing system 90 may comprise a computer or server and may be controlled primarily by computer readable instructions, which may be in the form of software, wherever, or by whatever means such software is stored or accessed. Computing system 90 can execute or include logical entities such as Event Collection Service 602, Event Collection Policy 604, Event Collection Triggers 606 Event Collection Execution 608, Set Policy 610, Get Policy 612, Set Triggers 614, Get Triggers 616, Record Event 618, Get Event Record 620, Triggers 802, AE 104 1302 and 1304, Service Exposure Component 106, Service Component 115 and 116, Network Service Utilization Component 114, Remote Service Exposure Component 108, CSE 102 1302 and 1304, NSE 112 and services 1306 and logical entities to produce GUIs such as GUI 1402. Computing system 90 can be an M2M device, user equipment, gateway, UE/GW or any other nodes including nodes of the mobile care network, service layer network application provider, terminal device 18 or an M2M gateway device 14 for example. Such computer readable instructions may be executed within a processor, such as central processing unit (CPU) 91, to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that performs additional functions or assists CPU 91. CPU 91 and/or coprocessor 81 may receive, generate, and process data related to the disclosed systems and methods for E2E M2M service layer sessions, such as receiving session credentials or authenticating based on session credentials.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain communication circuitry, such as for example a network adaptor 97, that may be used to connect computing system 90 to an external communications network, such as network 12 of FIG. 15A and FIG. 15B, to enable the computing system 90 to communicate with other nodes of the network.

It is understood that any or all of the systems, methods, and processes described herein may be embodied in the form of computer executable instructions (i.e., program code) stored on a computer-readable storage medium which instructions, when executed by a machine, such as a node of an M2M network, including for example an M2M server, gateway, device or the like, perform and/or implement the systems, methods and processes described herein. Specifically, any of the steps, operations or functions described above, including the operations of the gateway, UE, UE/GW, or any of the nodes of the mobile core network, service layer or network application provider, may be implemented in the form of such computer executable instructions. Logical entities such as Event Collection Service 602, Event Collection Policy 604, Event Collection Triggers 606 Event Collection Execution 608, Set Policy 610, Get Policy 612, Set Triggers 614, Get Triggers 616, Record Event 618, Get Event Record 620, Triggers 802, AE 104 1302 and 1304, Service Exposure Component 106, Service Component 115 and 116, Network Service Utilization Component 114, Remote Service Exposure Component 108, CSE 102 1302 and 1304, NSE 112 and services 1306 and logical entities to produce GUIs such as GUI 1402 may be embodied in the form of the computer executable instructions stored on a computer-readable storage medium. Computer readable storage media include both volatile and nonvolatile, removable and non-removable media implemented in any non-transitory (i.e., tangible or physical) method or technology for storage of information, but such computer readable storage media do not includes signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which can be used to store the desired information and which can be accessed by a computer.

In describing preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

What is claimed:

1. A node comprising a processor, a memory, and communication circuitry, the node being connected to a communications network via its communication circuitry, the node further including computer-executable instructions stored in the memory of the node which, when executed by the processor of the node, perform the functions of a service event collection component and cause the node to:
store an event collection policy; and
set an event collection trigger, the event collection trigger being based at least part on the event collection policy, the event collection trigger being set at a service.

2. The node of claim 1, wherein the computer-executable instructions further cause the node to receive an event record from the service after the event occurs at the service.

3. The node of claim 1, wherein the computer-executable instructions further cause the node to distribute the event collection policy to another location.

4. The node of claim 1, wherein the computer-executable instructions further cause the node to receive an event collection policy request.

5. The node of claim 1, wherein the computer-executable instructions further cause the node to receive an event collection trigger request.

6. The node of claim 1, wherein the computer-executable instructions further cause the node to receive an event record request.

7. The node of claim 1, wherein the computer-executable instructions further cause the node to provide event records in response to the event record request.

8. The node of claim 1, wherein the event collection policy defines an event type.

9. The node of claim 1, wherein the service event collection component is a part of a service layer.

10. The node of claim 9, wherein the service event collection component is a part of a Service-Oriented Architecture (SOA) oneM2M service layer.

11. A method for use by a service event collection component at a node in a network, wherein the node comprises a processor and memory, and wherein the node further includes computer-executable instructions stored in the memory which, when executed by the processor, perform functions of service event collection component in the network, the method comprising:
storing an event collection policy; and
setting an event collection trigger, the event collection trigger being based at least part on the event collection policy, the event collection trigger being set at a service.

12. The method of claim 11 further comprising receiving an event record from the service after the event occurs at the service.

13. The method of claim 11, wherein the event collection policy is distributed by the event collection component to another location.

14. The method of claim 11, further comprising receiving an event collection policy request.

15. The method of claim 11, further comprising receiving an event collection trigger request.

16. The method of claim 11, further comprising receiving an event record request.

17. The method of claim 11, further comprising providing event records in response to the event record request.

18. The method of claim 11, wherein the event collection policy defines an event type.

19. The method of claim 11, wherein the service event collection component is a part of a service layer.

20. The method of claim 19, wherein the service event collection component is a part of a Service-Oriented Architecture (SOA) oneM2M service layer.
